(19) United States
(12) Patent Application Publication
(10) Pub. No.: US 2023/0233001 A1
(43) Pub. Date: Jul. 27, 2023

(54) SHELF EDGE PROTECTOR FOR ELECTRONIC SHELF LABELS

(71) Applicant: Carl Pomerantz, Beaconsfield (CA)

(72) Inventor: Carl Pomerantz, Beaconsfield (CA)

(21) Appl. No.: 17/942,569

(22) Filed: Sep. 12, 2022

Related U.S. Application Data
(60) Provisional application No. 63/361,883, filed on Jan. 27, 2022.

(51) Int. Cl. A47F 13/00

(52) U.S. Cl. CPC A47F 13/00; G09F 3/208

(57) ABSTRACT

The present invention describes a shelf edge protector for an electronic shelf label (“ESL”) to protect the ESL from impact disturbance, displacement, or dislodgement by a shopping cart, restocking cart, a person, or other causes. The protector has an upper and a lower portion, connected by a bend. The protector is made of a clear material and its upper portion attaches with rivets or other attachment mechanisms to the forwardmost region of the top surface of a display shelf. The protector has predrilled holes at 1-inch or ½-inch intervals to align with a shelf's holes so that product dividers can be installed anywhere along the length of the protector without the need to drill holes after installation. The holes may also be pressure-actuated. The protector's lower portion has rounded or chamfered corners for safety to prevent snagging on clothing or other elements that may brush up against the protector.

This application claims the priority of U.S. Provisional patent application No. 63/361,883, filed on Jan. 27, 2022.

The disclosed invention protects electronic shelf labels from damage and dislodging by customers and staff. It is easily installed without tools onto any standard shelf edge, and can be quickly removed.

### BACKGROUND

In retail, items need to be priced so that shoppers/clients can be made aware of an item's price prior to purchase. Up until the latter part of the twentieth century, most retailers ticketed individual products with pricing by gluing a label on each individual item. This was a clear way for customers to know pricing, but was very labor intensive for store personnel to do. It was also very complex to logistically control price changes.

Towards the end of the century, new merchandizing methods were developed so that ticketing individual items with price tags was replaced by placing a label or sticker on the shelf edge or merchandizing peg so that all products behind or above the price ticket (commonly known as a bin ticket) had a ticketed price. This “single price label per group” change represented a major labor savings to the retailer.

With advancements in technology at the end of the 20th century, it has become possible to replace these formerly paper, cardstock, or stickered price labels, with Electronic Shelf Labels (commonly referred to as ESLs).

ESL systems provide significant operational labor savings to the retailer. With traditional paper bin tickets, every time a price change occurs, there is data entry to register the price change, plus new bin tickets have to be printed, sorted, old tickets removed, and new tickets manually inserted. Labor time involved, on average, is estimated at several minutes per label price change.

With ESLs, price changes can be wirelessly conducted, automatically and electronically updated, and changed. Furthermore, the ESL labels themselves can also display additional data beyond price, such as inventory information. Accuracy of information is improved. Within seconds, prices on the ESL's can be electronically updated across multiple systems, so pricing can quickly be changed to stay competitive and match the competition.

This yields improved retailer productivity, pricing accuracy, and price agility for the retailer. A further benefit and goal is improved promotional opportunities, and better communication of pricing information to shoppers.

The retailer's shelf edges feature an extruded plastic strip, so that a channel is formed, into which the ESL can be snapped into place and accommodated. While it is important that the ESL engages firmly into the channel, it is problematic if this fit is too tight; this then renders the ESL too difficult for store personnel to engage, and then to remove and relocate when desired.

The front face of the strip features a pair of engaging lips to accommodate the ESL's engaging tabs. With this assembly, the ESL can be attached and now display pricing information about items behind the ESL.

The tightness of fit between the molded ESL, the extruded track's engaging lips, and track's front face, is difficult to consistently control during fabrication of these two separate parts. As a result, this tightness of fit often varies.

When the fit of the ESL to the track is too loose, the ESL tends to slide along the track too easily when accidentally disturbed by a customer or passerby. This is problematic, as the ESL is then no longer indicating the correct price and other info, in front of the proper product.

The ESL is comprised of an assembly that includes a battery, a display face, and sophisticated, miniaturized internal electronics. All of this is housed in a relatively, somewhat fragile, plastic molded housing.

In the course of normal activity in a store, the ESLs in place on a shelf edge can be subject to significant physical disturbance by shoppers and store personnel.

One form of disturbance is via direct impact, for example from a shopping cart, or a store associate's stock-fulfilling cart, lift truck, or jigger used while moving skidded merchandise. Other examples of disturbances include ESLs accidentally being hit by shoppers or store personnel, when people place or remove merchandise, or simply by people accidentally bumping into the ESLs when walking too close by the ESLs. As well, ESL disturbance occurs by the cleaning personnel while using floor cleaning, mopping, sweeping and buffing equipment. Also, when the ESL assemblies are easy to displace, customers can be inclined to simply slide or displace the ESL as a form of absent mindedly fidgeting.

In some cases, a direct heavy impact can immediately break the ESL. A more lateral collision can lead to lateral displacement of the ESL, either from the strip, or the ESL and strip assembly can be together laterally displaced. In other instances, a lateral hit can result in the ESL detaching from the strip and the ESL falling to the floor, or into the shelf. The strip remains empty in place, while the ESL might break on impact on the floor, be run over with a shopping cart wheel, stepped on and broken, or simply lost or misplaced.

In other instances, the ESL remains attached to the strip, and both are dislodged as a unit, and slide literally, fall and break, or are lost. In other instances, both are dislodged and separated.

In all of the above (and other examples of ESL disturbance), displacement, dislodgement, and breakages, the central and most critically important function of the ESL, which is to accurately display the pricing in front of the appropriate group of articles, is rendered completely ineffective. A displaced or broken ESL therefore creates costly operational chaos for the retailer and their shoppers.

In one prior art, a snap-on cover is comprised of a flat clear piece of plastic, sized to precisely match each ESL's front window. It can be held in place either with adhesive or featuring a border that snaps onto the outside perimeter of the ESL. While this art can serve to protect the ESL window from a direct hit, it does not provide any protection from all the other forms of disturbance, such as a lateral collision causing breakage, dislodgement or displacement.

Another common prior art is a clear plastic extruded protector that typically runs the entire length of the shelf. The art features an adhesive strip that runs the full length of the protector, plus a hinge line along its length to allow access to the ESL protected by the strip.

This art has several shortcomings that severely hamper its effectiveness: it obstructs the front row of the shelf's holes, therefore precluding the use of shelf dividers unless holes are laboriously drilled into the protector by store personnel. This requires tools, and is difficult to do safely without training. During drilling, shards of material can be dislodged as projectiles, thereby requiring the store to restrict access to the specific aisles to customers and non-essential personnel. If such safety precautions are not taken, the store can be liable for personal injury caused by such projectiles.

Using an adhesive to bind the protector to the shelf has several significant drawbacks. First, it limits installation strictly to trained/more senior personnel, as precision and skill are required. Placement has to be precise, and untrained and unskilled personnel, who generally make up the vast majority of retailing staff, are ill-equipped to do this properly.

As the protector needs strength to sustain impact from shopping carts and the like, a strong adhesive bond is required. As a result, the protector cannot be repositioned, and upon removal, the adhesive damages the shelf's upper face such, as removing shelf paint, or leaving unsightly adhesive residues.

A further drawback of this means of attachment is that a raised lip is created across the entire upper edge of the shelf's face. This raised lip is obtrusive and renders the removal of product from the shelf much more difficult for customers and store personnel. A further unintended defect is that the lip is also prone to snagging and detachment during product removal, particularly when dragging heavier items off the shelf.

In this prior art, once the protector is in place, it is necessary that store personnel can still have access to ESLs underneath, in cases where personnel need to remove an ESL or add an ESL to the strip. The prior art accommodates this need by incorporating a flexible hinge along the length of the protector. Although this hinge does render the ESL accessible, this hinge diminishes the overall rigidity and protective ability of the protector to absorb shocks from blunt impact.

The prior art also features sharp exterior corners. Aside from creating a safety hazard to passersby, this feature also renders the strip's extremities prone to snagging onto passing shopping carts or clothing of passers-by.

Furthermore, often a shelf features a small number of different products. Typically the retailer uses one ESL per product. If there is only one product on the shelf, one single ESL is needed. However, the prior art only gives the option to adhere an entire shelf-length protector in place, while in reality only a short length of a repositionable protector would be much more efficient and functional.

There is also known prior art for protecting shelf edges with 3 to 5 predrilled holes for attachment. Although these predrilled holes do facilitate attachment of the protector to shelves, they are flawed because they do not recognize, nor allow for access, to other holes (e.g. shelf divider placement).

Also, because of product placement on shelves, in some cases having only five holes in predetermined locations is not desirable, as the retailer is now forced to only use specific holes for attachment that perhaps is not ideally located/accessible for some shelf product layout situations. In extreme high-activity exposure zones, sometimes more than five attachment points are desirable for improved impact resistance.

### OBJECT OF THE PRESENT INVENTION

The object of the current invention is to provide an improved means of protecting shelf edge Electronic Shelf Label (referred to as “ESL”) assembly against impact, disturbance, displacement or dislodgement.

In one embodiment of the invention, the invention is comprised of a transparent plastic protector slightly wider than the width of the ESL it will protect. The invention can feature holes with spacing to match some or all of the holes on the forwardmost region of the top face of the shelf, so that upon installation, shelf holes are left unobstructed and accessible for shelf dividers and the like. All corners of the protector are rounded or chamfered for safety and to prevent snagging. The protector of the present invention attaches to the shelf via fasteners such as bolts, quick-engage rivets, zip ties, or other attachment means, so that the invention is firmly and easily mounted to the shelf edge and can be easily relocated when desired. The forward front face of the protector is inclined downwards and dimensioned to form a shield for the ESL, thereby protecting it from impact and disturbance by a shopping cart, restocking cart, accidental contact by a shopper or employee, or vandalism.

It is notable that the invention's holes can align with a standard retail shelf's holes, typically by ½-inch or 1-inch centers. In this way, shelf holes are left accessible and unobstructed for attachment of shelf dividers or the like.

As the design and attachment means render the protector of the present invention easily relocatable, unlike the prior art, no hinge is necessary to allow access to the ESL. As a result, the protector of the present invention is more rigid, offers enhanced structural integrity, longer useful lifespan, and better protection and shielding for the ESL.

The invention provides structurally sound protection when at least two holes are used to attach the invention to the shelf edge. For optimum structural strength, ideally the second-last outer holes are used for this purpose.

As opposed to prior art that creates an obtrusive lip along the entire shelf edge preventing heavier products from being slid off the shelf towards the customer, the invention allows for this lip to be limited strictly to the narrow zone that constitutes the width of the ESL.

The invention and attachment means renders it easily relocatable with zero shelf surface defacement upon removal. The invention is also completely reusable. The invention can be dimensioned such that embodiments can be attached directly adjacent to one another, with no obstruction of shelf holes (other than where the fasteners attach the invention to the shelf).

In another embodiment of the invention, the protector can be longer, and can extend across multiple ESLs and employ similar attachment means and features, including leaving some or all of the shelf holes accessible. In yet another of these extended embodiments, the lip that extends onto the shelf top is only employed in the vicinity of the rivet anchor points, so that a continuous obtrusive lip on the shelf edge is avoided and heavier products can be slid off the shelf without the lip causing interference.

Another major advantage of this invention over the prior art is that there is no skill required to properly install the invention. Personnel simply have to align the protector over the holes and install the fastener. Even if it is accidentally placed in the wrong transverse shelf position, fasteners such as rivets can be disengaged, and the invention can be easily detached and relocated as desired.

There are several further advantages of the invention's ability to be of limited length and dimensioned to protect just one ESL. With the prior art strip, if a portion of the strip is damaged, the entire strip must be replaced. With the current invention, the invention strictly protects the ESL from impact, so the potentially-damaged target is effectively smaller.

For example, if a shelf has only one ESL approximately 3 inches in width, and the present invention's embodiment is four inches wide, then, on a four-foot shelf, the potential impact point of a corner of a perpendicular accidental charging shopping cart is strictly the four-inch-wide protector. If the cart's corner collides with any other part of the shelf face, the result of the collision is inconsequential. However, with the prior art being a full-length strip, the target is potentially now the full four-foot length, and if the collision occurs and damages the protector along any of the four-foot length, the entire protector must be replaced (see FIGS. 9 and 10). As well, if the collision occurs in close proximity to the either side of the ESL, the prior art will transfer the impact to the ESL by virtue of the prior art being a long strip. In the present invention, no stress is imparted to the ESL from a collision in close proximity to the ESL.

In another embodiment of the invention, the invention's edges can be tapered so that less of a lip is created on the shelf top, and heavier products can be slid off the front of the shelf without interference.

The invention quickly attaches onto the top face of the shelf edge so that the protector serves to protect the ESL from damage due to blunt impact. It also serves to more firmly retain the ESL to the strip itself so that the ESL is precluded from being dislodged or laterally displaced from the strip. The invention can also serve to reinforce the shelf strip's fixture attachment means, so that the combined assemblage is much less prone to being displaced or detached from the shelf edge.

The invention features rounded or chamfered corners for safety, and to prevent snagging from passers-by. Material of the invention is strong enough to absorb and protect the ESL from impact, and must be clear so as not to obstruct clarity of the ESL's digital display. It also must not obscure scanning of the ESLs from employee's hand-held barcode scanners.

### BRIEF DESCRIPTION OF THE DRAWINGS

FIG. 1 shows a perspective view of the first embodiment of the present invention, namely a short protector.

FIG. 2 shows a side view of a transition between inoperative and operative mode of a preferred fastener, namely a rivet.

FIG. 3 shows a front view of the first embodiment with an ESL, during installation of fasteners.

FIG. 4 shows a front view of the first embodiment with an ESL, after installation of fasteners.

FIG. 5 shows a perspective view of the second embodiment of the present invention, namely a long protector.

FIG. 6 shows a perspective view of the first embodiment with through-openings being slots instead of round holes.

FIG. 7 shows a perspective view of the first embodiment with through-openings being square holes instead of round holes.

FIG. 8 shows a perspective view of the second embodiment installed onto a shelf by using shelf dividers as fasteners.

FIG. 9 shows a side perspective view of prior art, attached to a shelf with adhesive.

FIG. 10 shows a perspective view of prior art after damage.

FIG. 11 shows a front view of a third embodiment of the present invention.

FIG. 12 shows a perspective view of a variant of the second embodiment with six through-openings.

FIG. 13 shows a perspective view of the second embodiment with chamfered corners.

FIG. 14 shows a perspective view of the first embodiment with chamfered corners.

FIG. 15 shows a perspective view of another variant of the second embodiment with two rows of holes to accommodate another model of a display shelf.

FIG. 16 shows another variant of the second embodiment as seen on FIG. 13 with two rows of holes.

FIG. 17 shows a variant of the first embodiment with through-openings being transverse slots rotated 90 degrees to the slots shown on FIG. 6.

FIG. 18 shows the first embodiment with through-openings being pressure-actuated holes.

### DETAILED DESCRIPTION OF THE PREFERRED EMBODIMENTS

The present invention is a protector for one or a plurality of Electronic Shelf Labels (ESL). The protector shields ESLs from impacts that would otherwise dislodge or damage ESLs. The protector is easily installed or removed by a store staff member with little or no skill.

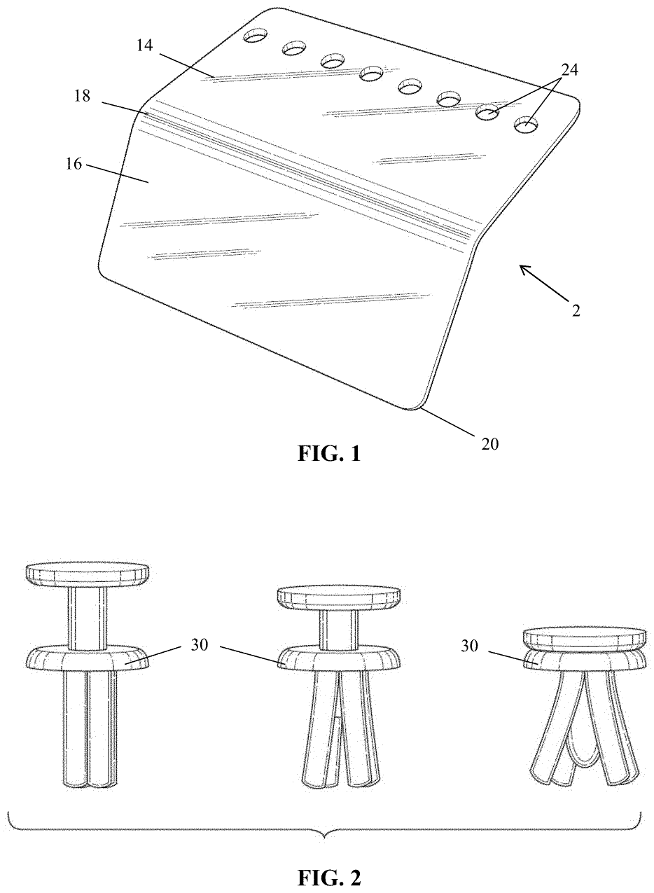

Referring now to drawings, FIG. 1 shows the first preferred embodiment of the present invention, namely a short protector 2 for one ESL, comprising a substantially horizontal upper portion 14 with a plurality of through-openings 24, connected to lower portion 16 via bend 18, said lower portion 16 being under a predetermined angle with relation to upper portion 14. Corners 20 of lower portion 16 are curved to prevent snagging. Protector 2 is slightly wider the width of an ESL. Through-openings 24 are spaced ½ inch apart.

FIG. 2 shows the transition of a preferred fastener 30 between inoperative or pre-installation mode and operative or post-installation mode. Preferred fastener 30, namely a plastic anchor rivet, comprises a body and a pin, said body adapted to expand once pin is inserted.

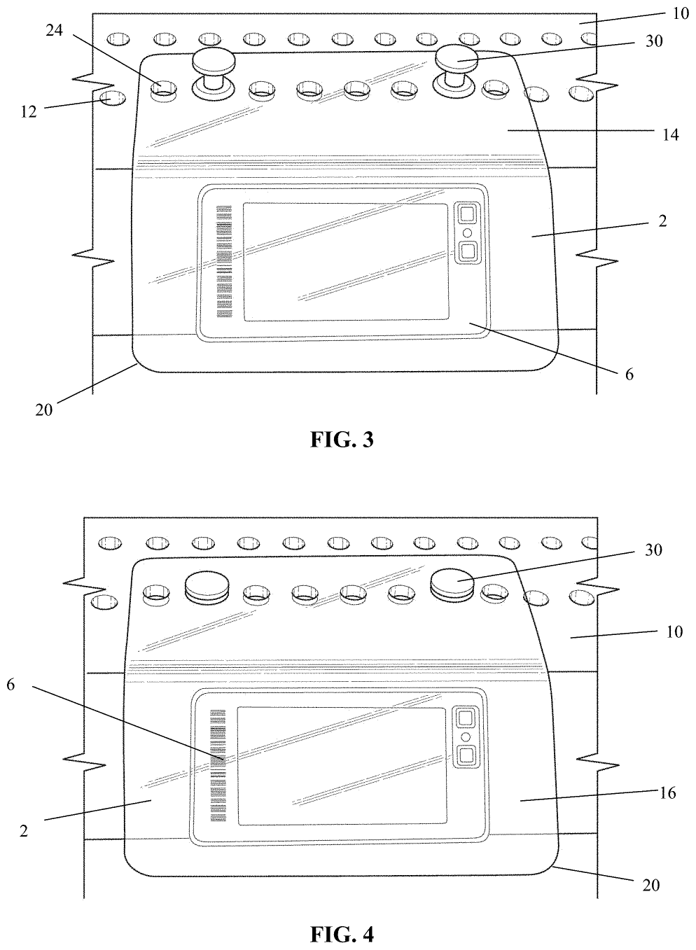

FIG. 3 demonstrates mid-installation process of protector 2 onto forwardmost region of top face of shelf 10, wherein fasteners 30 are inserted into through-openings 24 of upper portion 14, and subsequently into through-openings 12 located in forwardmost region of top face of shelf 10. Protector 2 is installed to substantially cover ESL 6.

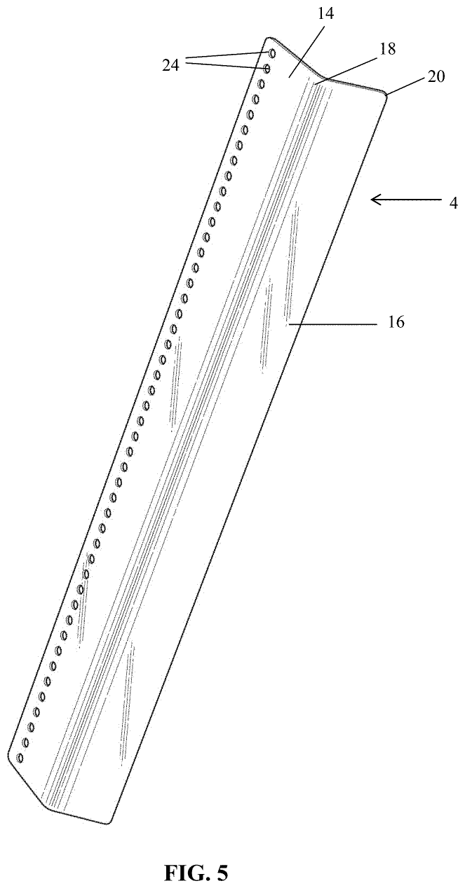

FIG. 4 shows the installed protector 2 over ESL 6, wherein fasteners 30 are fully inserted into forwardmost region of top face of shelf 10's through-openings 12. Protector 2's lower portion 16 comprises rounded corners 20 for safety and to prevent snagging.

FIG. 5 demonstrates the second preferred embodiment of the present invention, namely a long protector 4, adapted to protect a plurality of ESLs. Protector 4 comprises a substantially horizontal upper portion 14 connected to lower portion 16 via bend 18, lower portion 16 being at a pre-determined angle to upper portion 14. A plurality of through-openings 24 are located in proximity to the distal edge of upper portion 14. Corners 20 of lower portion 16 have a rounded configuration to prevent snagging, and for safety.

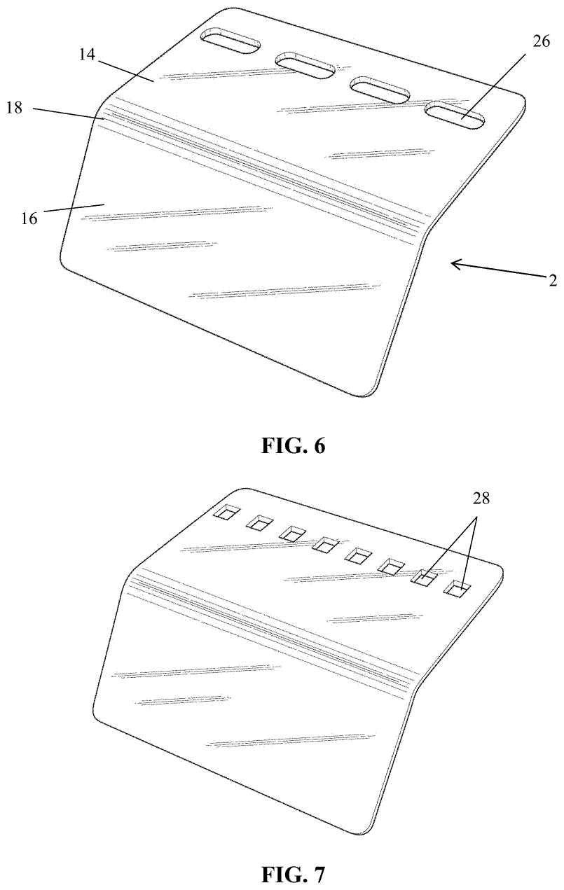

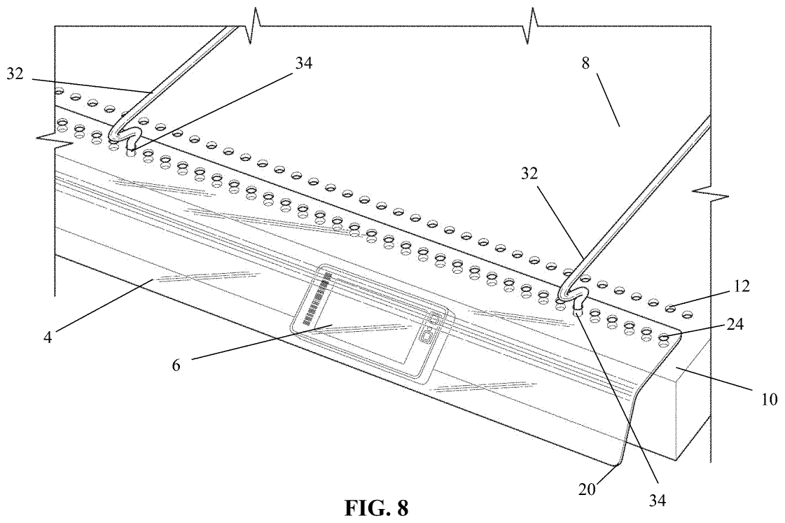

FIG. 6 shows a variant of the first embodiment 2 with through-openings being slots 26 instead of round holes 24. Slots 26 allow for installation on forwardmost regions of top face of shelf 10 with non-standard through-openings 12 configurations. FIG. 7 shows first embodiment 2 with square through-openings 28 instead of round holes 24, to adapt to different models of shelves. It should be noted that through-openings 24 can be of other shapes other than slots 26 or squares 28, such as hexagons, octagons, or the like.

FIG. 8 shows the second embodiment 4 installed on shelf 8's forwardmost region of top face of shelf 10 using shelf dividers 32. A standard shelf divider 32 comprises a prong 34 adapted to be inserted in forwardmost region of top face of shelf 10's through-opening 12 to prevent products from co-mingling on the same shelf 8. Prong 34 can be used as a fastener to attach protector 2 or 4 to forwardmost region of top face of shelf 10 by first being inserted into through-opening 24 of protector 2 or 4, and subsequently into through-opening 12 located on forwardmost region of top face of shelf 10. Therefore, protector 2 or 4 is immobilized over ESL 6.

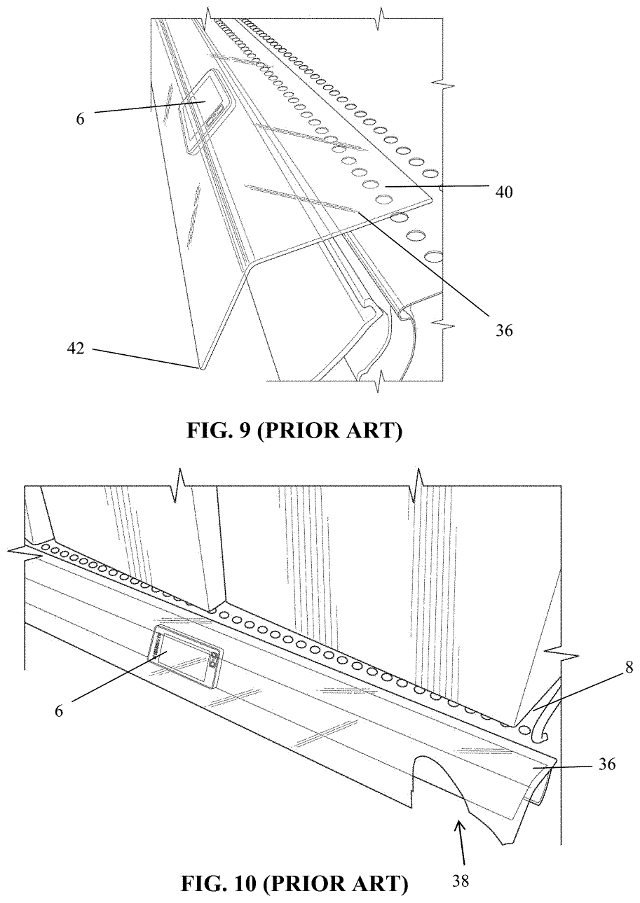

FIGS. 9 and 10 show prior art 36 comprising a protector installed on forwardmost region of top face of shelf 10 using adhesive 40. Prior art 36 obscures through-openings 12 on forwardmost region of top face of shelf 10, prohibiting installation of shelf dividers 32 unless a skilled person manages to drill a corresponding hole in prior art 36, which is a dangerous and complicated procedure. In addition, prior art 36 comprises square corners 42 that are prone to snagging on clothing and store equipment. As seen on FIG. 10, if something snags on corner 42, there is a high probability that prior art 36's corner 42 will fracture or shatter, and cause damage 38, thereby necessitating replacement of the entire protector of prior art 36.

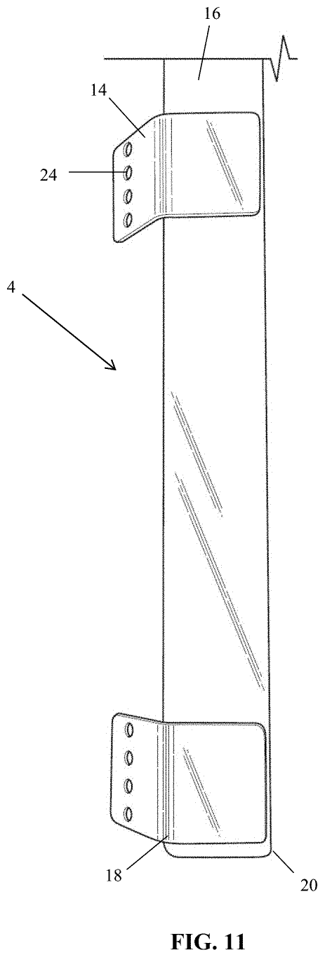

FIG. 11 demonstrates a variant of the second preferred embodiment 4, wherein upper portion 14 is intermittent with relation to lower portion 16. Upper portion 14 only extends where the attachment points are necessary for installation to forwardmost region of top face of shelf 10. This variant reduces the continuous lip created by the distal edge of upper portion 14 as seen on FIG. 5, thereby not interfering with the ability to slide heavier objects off the shelf by a customer.

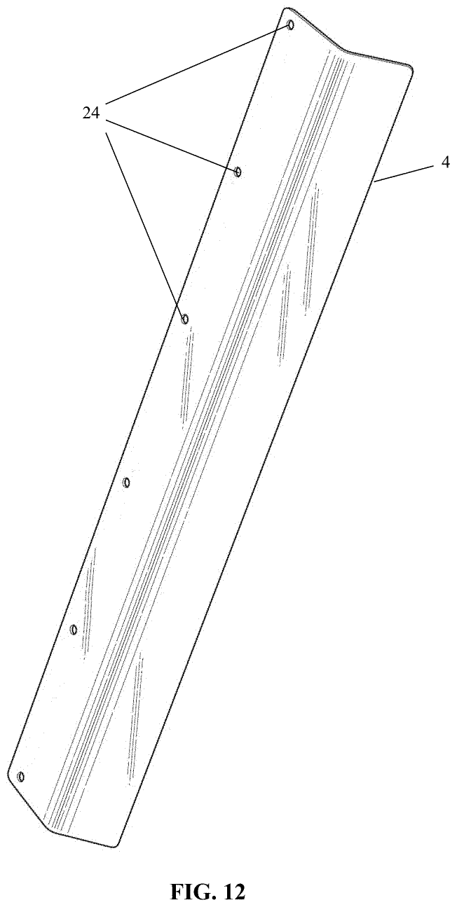

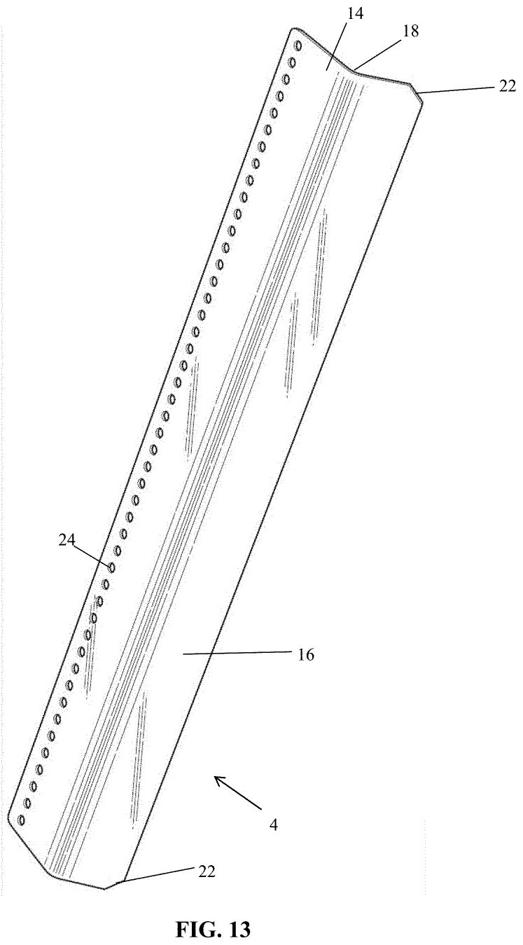

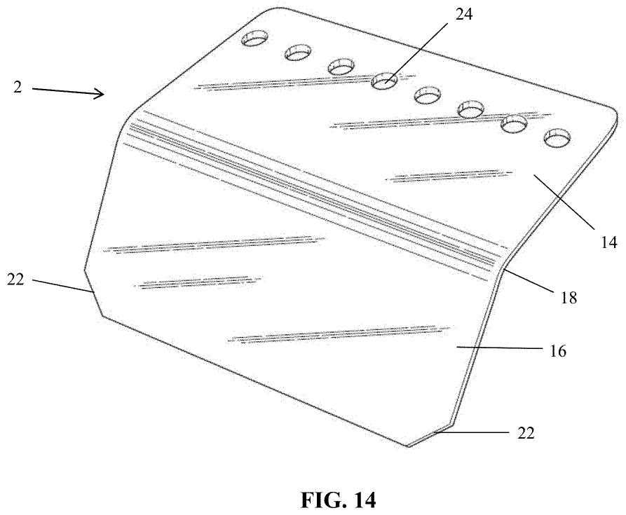

FIG. 12 shows another variant of the second preferred embodiment 4, with six through-openings 24. FIGS. 13 and 14 show first and second embodiments 2 and 4 with chamfered corners 22 instead of rounded or curved corners 20. It should be noted that one or more chamfers 22 are possible on a single corner.

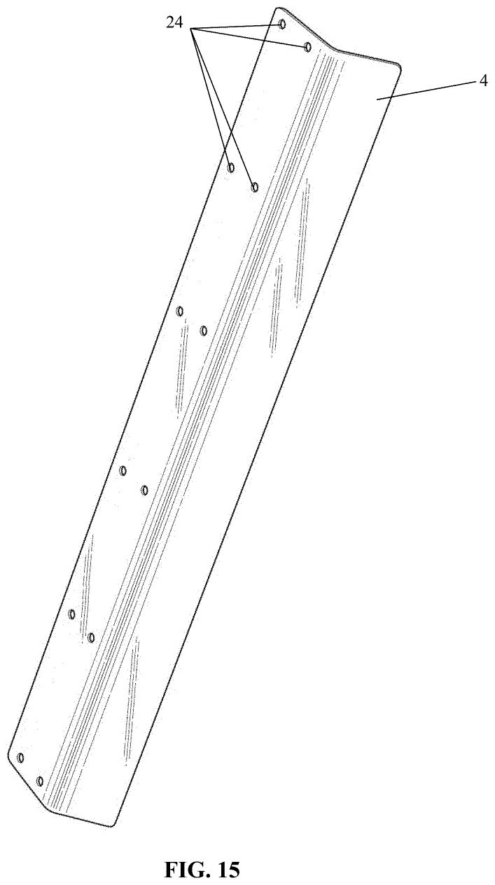

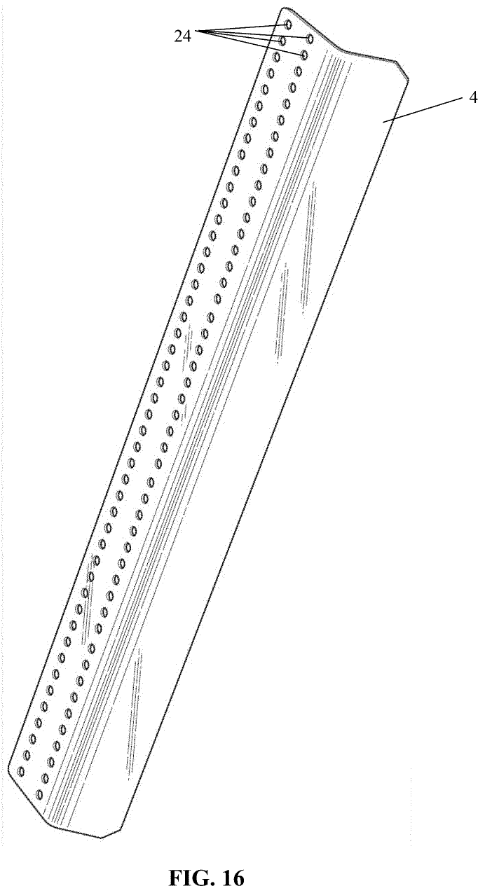

FIG. 15 shows yet another variant of the second preferred embodiment 4 with two rows of six holes 24 to accommodate some display shelves 8 with a different orientation of holes 12. FIG. 16 shows yet another variant of the second preferred embodiment 4 with two rows of a multitude of holes 24.

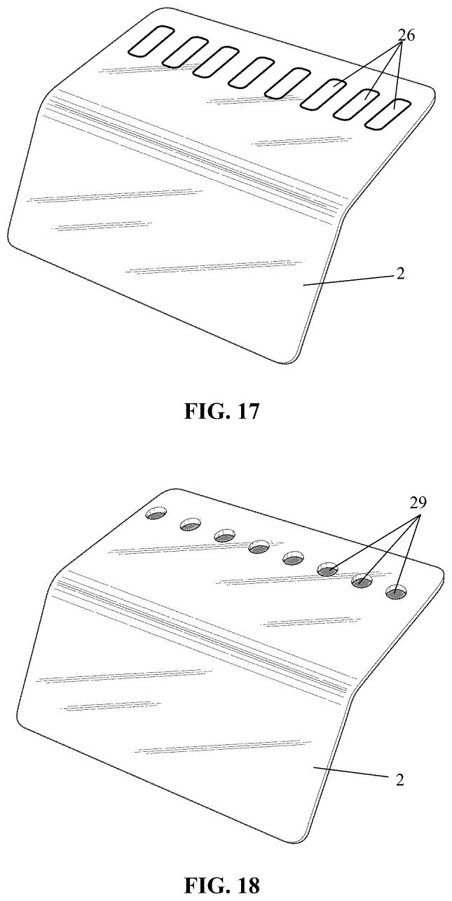

FIG. 17 shows the first preferred embodiment 2 with through-openings being slots 26 that are oriented at 90 degrees to slots 26 seen on FIG. 6. FIG. 18 shows the first preferred embodiment 2 with through-openings being pressure-actuated holes 29, namely holes that are not completely drilled through the entire thickness of upper portion 14, but drilled to a threshold where an object such as prong in shelf divider 34 can be used to punch or pushed through pressure-actuated hole 29 to convert pressure-actuated hole 29 into hole 24, without damaging protector 2 or 4.

In practice, on a standard store shelf 8, protector 2 or 4 is aligned with ESL 6, and through-openings 24 are aligned with through-openings 12 of forwardmost region of top face of shelf 10. Fasteners 30 or prongs 34 of shelf dividers 32 are inserted into through-openings 24, and subsequently into through-openings 12, thereby locking protector 2 or 4 onto forwardmost region of top face of shelf 10, covering ESL 6. If protector 2 or 4 has to be removed, the installation procedure is reversed.

In non-standard store shelf scenarios, protectors 2 or 4 with variants of through-openings 26 or 28 can be used. As mentioned before, through-openings of upper portion 14 can be of any configuration, depending on the shape of forwardmost region of top face of shelf 10's through-openings 12.

In some applications, protectors 2 or 4 with pressure-actuated through-openings 29 need to be used. In such cases, a tool such as a prong 34 of shelf divider 32 can be pushed through opening 29 thereby creating a through-opening 24. It should be noted that no drill is necessary to convert pressure-actuated through-opening 29 into through-opening 24, since pressure-actuated through-opening 29 is pre-drilled to the threshold where a simple push of said prong 34 is sufficient to create a full through-opening 24 without structurally damaging protector 2 or 4's upper portion 14.

1. A shelf edge protector for an electronic shelf label (“ESL”) adapted to protect said ESL from impact disturbance, displacement, or dislodgement, comprising
a body made of a transparent rigid material comprising
an upper portion adapted to attach to a forwardmost region of top face of shelf, and
a lower portion connected to said upper portion via a bend, said lower portion adapted to cover said ESL,
said upper portion comprising through-openings to allow unobstructed accessibility through said upper portion to at least six through-openings in said forwardmost region of top face of shelf.

2. A shelf edge protector for an ESL according to claim 1, wherein corners of said lower portion are rounded for safety and to prevent snagging.

3. A shelf edge protector for an ESL according to claim 1, wherein corners of said lower portion are chamfered for safety and to prevent snagging.

4. A shelf edge protector for an ESL according to claim 1, wherein said upper portion of said body is attached to said forwardmost region of top face of shelf via fasteners so that said body is firmly and easily attached to said forwardmost region of top face of shelf, and can be easily removed when desired.

5. A shelf edge protector for an ESL according to claim 1, wherein said upper portion's through-openings are one inch apart, aligning with said forwardmost region of top face of shelf's through-openings, also one inch apart, thus leaving said forwardmost region of top face of shelf's through-openings accessible and unobstructed.

6. A shelf edge protector for an ESL according to claim 1, wherein said upper portion's through-openings are ½ inch apart, aligning with said forwardmost region of top face of shelf's through-openings, also ½ inch apart, thus leaving said forwardmost region of top face of shelf's through-openings accessible and unobstructed.

7. A shelf edge protector for an ESL according to claim 1, wherein said protector is attached to said forwardmost region of top face of shelf via at least two through-openings, and for optimal structural strength, the second-last through-openings from an extremity of said upper portion are used for this purpose.

8. A shelf edge protector for an ESL according to claim 1, wherein the width of said body substantially matches the width of said ESL.

9. A shelf edge protector for an ESL according to claim 1, wherein said protector covers a plurality of ESLs.

10. A shelf edge protector for an ESL according to claim 1, wherein said material is plastic.

11. A shelf edge protector for an ESL according to claim 1, wherein said upper portion is attached to said forwardmost region of top face of shelf using a shelf divider, wherein said shelf divider comprises a protrusion adapted to be inserted through said upper portion's through-opening, and subsequently through said forwardmost region of top face of shelf's through-opening.

12. A shelf edge protector for an ESL according to claim 1, wherein said upper portion through-openings are round.

13. A shelf edge protector for an ESL according to claim 1, wherein said upper portion through-openings are slots.

14. A shelf edge protector for an ESL according to claim 1, wherein said upper portion through-openings are pressure-actuated holes.

15. A shelf edge protector for an electronic shelf label (“ESL”) adapted to protect said ESL from impact disturbance, displacement, or dislodgement, comprising
a body made of a transparent rigid material including
an upper portion adapted to attach to a forwardmost region of top face of shelf, and
a lower portion bent under a predetermined angle and adapted to cover said ESL,
said lower portion comprising snag-free transitional corners,
said corners being curved arcs.

16. A shelf edge protector for an electronic shelf label (“ESL”) adapted to protect said ESL from impact disturbance, displacement, or dislodgement, comprising
a body made of a transparent rigid material comprising
an upper portion adapted to attach to a forwardmost region of top face of shelf, and
a lower portion bent under a predetermined angle and adapted to cover said ESL,
said lower portion comprising snag-free transitional corners,
said corners comprising one or a plurality of chamfers.

17. A shelf edge protector for an electronic shelf label (“ESL”) adapted to protect said ESL from impact disturbance, displacement, or dislodgement, comprising
a body made of a transparent rigid material comprising
an upper portion adapted to attach to a forwardmost region of top face of shelf, and
a lower portion bent under a predetermined angle and adapted to cover said ESL,
wherein said lower portion comprises tapered corners to prevent snagging, said upper portion comprising through-openings aligning with through-openings on said forwardmost region of top face of shelf so that upon installation, at least half of through-openings of said forwardmost region of top face of shelf remain unobstructed.
